(19) United States
(12) Patent Application Publication
(10) Pub. No.: US 2016/0340876 A1
(43) Pub. Date: Nov. 24, 2016

(54) FRONT-KNOB TYPE MULTI-FUNCTION SHOWER ARM AND METHOD OF IMPLEMENTING THE SAME

(71) Applicant: Xiamen Runner Industrial Corporation, Xiamen (CN)

(72) Inventors: Wen-kun Lin, Xiamen (CN); Yuan-shan Liang, Xiamen (CN); Sheng-chao Dai, Xiamen (CN)

(21) Appl. No.: 15/148,357

(22) Filed: May 6, 2016

(30) Foreign Application Priority Data
May 18, 2015 (CN) 201510249977.1

(51) Int. Cl. E03C 1/04; F16K 11/085; E03C 1/02

(52) U.S. Cl. CPC E03C 1/0408; E03C 1/025; F16K 11/0853

(57) ABSTRACT

A front-knob type multi-function shower arm and method of implementing the same. The method includes the following two water output modes: (1) a shower head water output mode: when rotating upward a knob on a front face, a three-way splitter is brought to connect a water input channel of a main body to a shower head water output channel, so that water flows to the shower head water output channel, and then it flows directly out from a shower head; and (2) a shower water output mode: when rotating downward a knob on a front face, the three-way splitter is brought to connect the water input channel of the main body to the shower water output channel, so that water flows to the shower water output channel, and then it flows out a shower from an outside connected shower hose.

### BACKGROUND OF THE INVENTION

1. Field of the Invention

The present invention relates to a shower arm, and in particular to a front-knob type multi-function shower arm and method of implementing the same, used in bathing and sanitary equipment.

2. The Prior Arts

Conventionally, the structure of a shower arm is simple and easy, and it is only provided with a water input interface and a shower head interface. In application, it requires an additional and independent three-way splitter to perform switching between the shower head water output and the shower arm water output. Since the shower arm and the three-way splitter are separate pieces, user has to purchase and install them separately. As such, it has the problem of difficulties in equipment compatibility, installation, and application.

Therefore, presently, the design and performance of the shower arm is not quite satisfactory, and it leaves much room for improvement.

### SUMMARY OF THE INVENTION

In view of the problems and drawbacks of the prior art, the present invention provides a front-knob type multi-function shower arm and method of implementing the same, to overcome the shortcomings of the prior art.

In order to achieve the objective mentioned above, the present invention provides a front-knob type multi-function shower arm, including: a main body, a three-way splitter, and a knob. Wherein, the main body includes a water input interface, a shower head interface, and a shower interface. The water input interface is disposed at a rear end of the main body; the shower head interface is disposed at a front end upper portion of the main body, and is used for installing a shower head; and the shower interface is disposed at a front end bottom portion of the main body, and is used for connecting to a shower hose. The three-way splitter is disposed in the main body, for controlling flow of water to the shower head or a shower. And the knob is disposed at a front face of front end lower portion of the main body, and is used to operate the three-way splitter.

In an aspect of the present invention, the main body is of a V shape, and an axial line of the water input interface is parallel to ground. A connector is installed in the shower head interface through its inner threads for connecting a shower head. The connector is inclined downward, with its middle portion provided with a ring shape indent slot; and an O-shape tight seal ring is received in the ring shape indent slot, in tight seal contact with an inner wall of the shower head interface.

In another aspect of the present invention, the three-way splitter includes a core axis installed slantwise at a T-joint in the main body. An operation end of the core axis penetrating through a through hole in a center of a press disk, and is exposed to a front face of the main body. The press disk is locked tightly on the main body through using a screw, so that a knob is fastened onto the operation end of the core axis.

In a further aspect of the present invention, a ring shape indent slot is each provided on both ends of the core axis. The O-shape tight seal ring is sleeved around the ring shape indent slot in tight seal contact with an inner wall of the main body. In a middle portion and on a side of the core axis is provided with a positioning slot, in the positioning slot is provided with a tight seal plug for selectively sealing a shower head water output channel or a shower water output channel through using a tight seal spring. In the middle portion and on the other side of the core axis is provided with a water output slot, for connecting to the shower head water output channel or the shower water output channel. A water input hole is provided at a rear end of the core axis for connecting the water input channel and the water output slot. And a bottom portion of the water output slot is connected to a bottom portion of the positioning slot through a small hole.

In yet another aspect of the present invention, a plurality of ribs are disposed at the bottom portion of the water output slot, to slow down the speed of water flow.

In another aspect of the present invention, a flange is provided around a rear end outer side of the main body.

The present invention also provides a front-knob type multi-function shower arm water output method, comprising following two water output modes:

(1) a shower head water output mode: when rotating upward a knob on a front face, a three-way splitter is brought to connect a water input channel of a main body to a shower head water output channel, so that water flows to the shower head water output channel, and then it flows directly out from a shower head; and

(2) a shower water output mode: when rotating downward a knob on a front face, the three-way splitter is brought to connect the water input channel of the main body to the shower water output channel, so that water flows to the shower water output channel, and then it flows out a shower from an outside connected shower hose.

Compared with the Prior Art, the present invention has the advantages that, it combines the conventional shower arm and the three-way splitter together into one piece, while keeping their functions. Also, it solves the problem of the user having to purchase and install the two pieces separately. Therefore, it is novel in design, easy to install, convenient to use, and having a compact and handsome appearance. In addition, since the knob is disposed in the front face, thus further simplifying its operation.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a front-knob type multi-function shower arm according to an embodiment of the present invention;

FIG. 2 is an exploded view of a front-knob type multi-function shower arm according to an embodiment of the present invention;

FIG. 3 is a cross section view of a front-knob type multi-function shower arm when water is output from a shower head according to an embodiment of the present invention;

FIG. 4 is a cross section view of a front-knob type multi-function shower arm when water is output from a shower according to an embodiment of the present invention;

FIG. 5 is an enlarged view of a core axis according to an embodiment of the present invention; and

FIG. 6 is a cross section view of a core axis according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

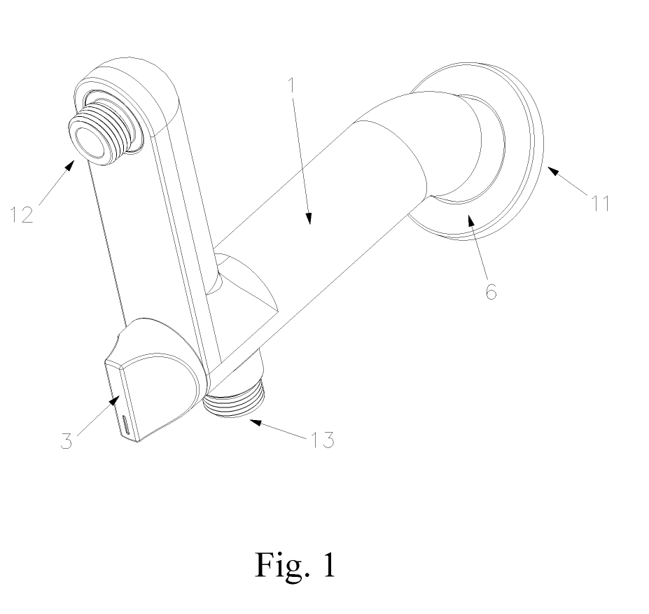

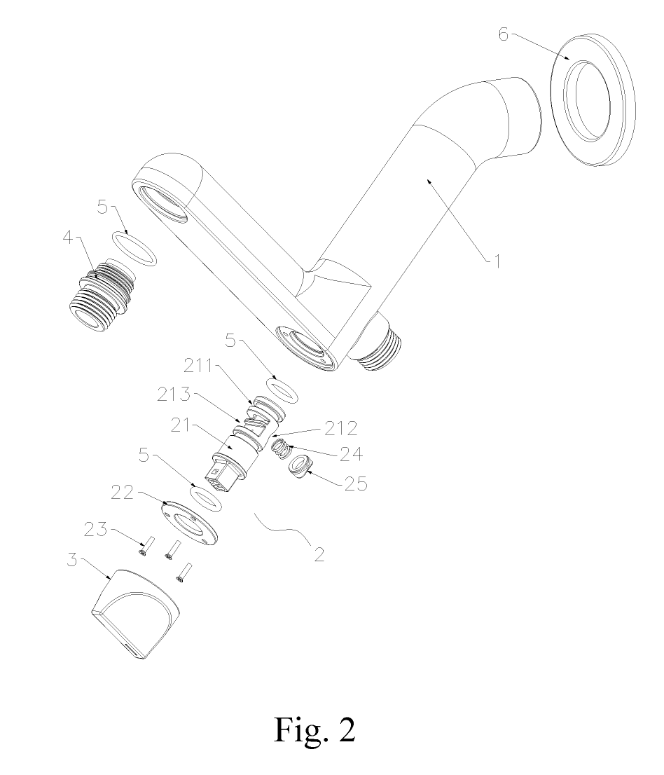

Refer to FIGS. 1 to 6 respectively for a schematic diagram of a front-knob type multi-function shower arm according to an embodiment of the present invention; an exploded view of a front-knob type multi-function shower arm according to an embodiment of the present invention; a cross section view of a front-knob type multi-function shower arm when water is output from a shower head according to an embodiment of the present invention; a cross section view of a front-knob type multi-function shower arm when water is output from a shower according to an embodiment of the present invention; an enlarged view of a core axis according to an embodiment of the present invention; and a cross section view of a core axis according to an embodiment of the present invention.

As shown in FIGS. 1 to 6, the present invention provides a front-knob type multi-function shower arm, including: a main body 1, a three-way splitter 2, and a knob 3. Wherein, the main body 1 includes a water input interface 11, a shower head interface 12, and a shower interface 13. The water input interface 11 is disposed at a rear end of the main body 1, and is provided with inner threads; the shower head interface 12 is disposed at a front end upper portion of the main body 1, and is used for installing a shower head; and the shower interface 13 is disposed at a front end bottom portion of the main body 1, and it is provided with outer threads, and is used for connecting to a shower hose. The three-way splitter 2 is disposed in the main body 1, for controlling flow of water to the shower head or a shower. And the knob 3 is disposed at a front face of front end lower portion of the main body 1, and is used to operate the three-way splitter 2.

In an embodiment of the present invention, the main body 1 is of a V shape, and an axial line of the water input interface 11 is parallel to ground. A connector 4 is installed in the shower head interface 12 through its inner threads for connecting a shower head. The connector 4 is inclined downward, so that the installed shower head is also inclined downward, to facilitate user taking a shower. The middle portion of the connector 4 is provided with a ring shape indent slot 211, and an O-shape tight seal ring 5 is received in the ring shape indent slot 211, in tight seal contact with an inner wall of the shower head interface 12. Through the outer threads at the lower end of the connector 4, the shower head can be connected directly, thus making its installation and detachment easy and convenient.

In an embodiment of the present invention, the three-way splitter 2 includes a core axis 21 installed slantwise at a T-joint in the main body 1. An operation end of the core axis 21 penetrating through a through hole in a center of a press disk 22, and is exposed to a front face of the main body 1. The press disk 22 is locked tightly on the main body 1 through using a screw 23, to make the core axis 21 positioned in the main body 1, while a knob 3 is fastened onto the operation end of the core axis 21.

In an embodiment of the present invention, a ring shape indent slot 211 is each provided on both ends of the core axis 21. The O-shape tight seal ring 5 is sleeved around the ring shape indent slot 211 in tight seal contact with an inner wall of the main body 1. In a middle portion and on a side of the core axis 21 is provided with a positioning slot 212, in the positioning slot 212 is provided with a tight seal plug 25 (for example, a cat eye pad) for selectively sealing a shower head water output channel or a shower water output channel through using a tight seal spring 24. In the middle portion and on the other side of the core axis 21 is provided with a water output slot 213, for connecting to the shower head water output channel or the shower water output channel. A water input hole 214 is provided at a rear end of the core axis 21 for connecting the water input channel and the water output slot 213.

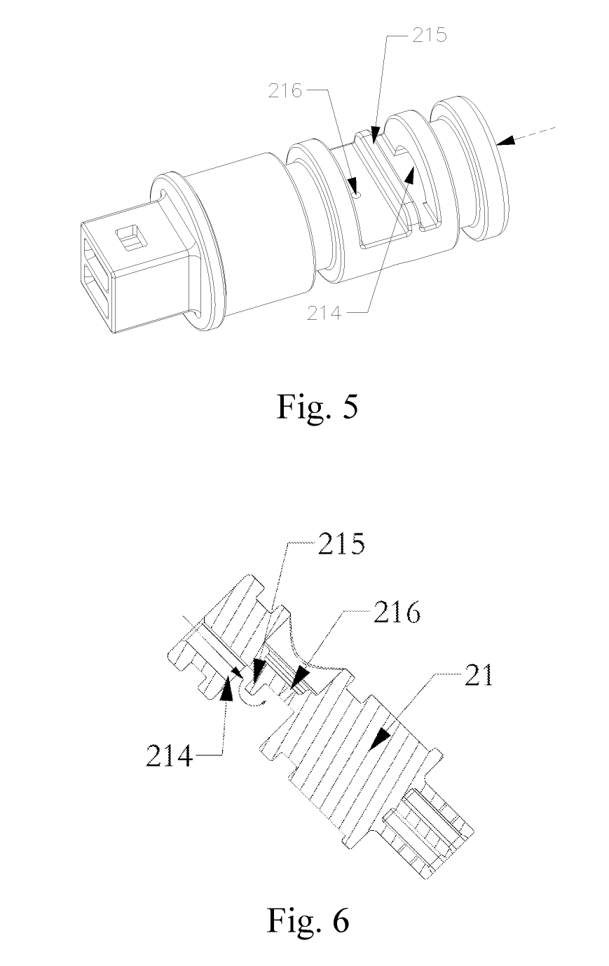

In an embodiment of the present invention, as shown in FIGS. 5 and 6, a bottom portion of the water output slot 213 is connected to a bottom portion of the positioning slot 212 through a small hole 216, such that water flows through the small hole 216 to press tightly against the tight seal plug 25, to achieve better tight seal effect. A plurality of ribs 215 are provided at the bottom portion of the water output slot 213, so that the water input from the water input hole 214 will impinge onto the ribs 215, to reduce the speed of the water flow, thus avoiding the knob being pressed too tight to rotate.

In an embodiment of the present invention, a flange 6 is provided around a rear end outer side of the main body 1, so that the connection of the main body 1 to the water input pipe built in the wall can be more secure, to make the entire outer appearance neat and compact.

The present invention also provides a front-knob type multi-function shower arm water output method, comprising following two water output modes:

(1) a shower head water output mode: when rotating upward a knob 3 on a front face, a three-way splitter 2 is brought to connect a water input channel of a main body 1 to a shower head water output channel, so that water flows to the shower head water output channel, and then it flows directly out from the shower head; and

(2) a shower water output mode: when rotating downward a knob 3 on the front face, the three-way splitter 2 is brought to connect the water input channel of the main body 1 to the shower water output channel, so that water flows to the shower water output channel, and then it flows out the shower from an outside connected shower hose.

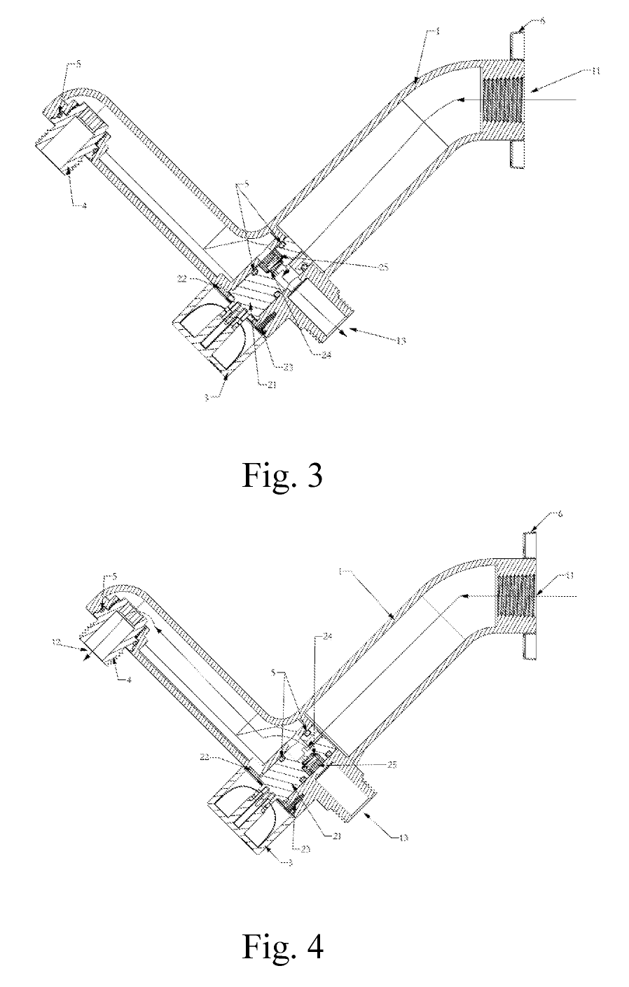

In an embodiment of the present invention, as shown in FIG. 3, when selecting the shower head water output mode, the tight seal plug 25 on the core axis 21 blocks the shower water output channel, to cause the connection of the water output slot 213 to the shower head water output channel.

In an embodiment of the present invention, alternatively, as shown in FIG. 4, when selecting the shower water output mode, the tight seal plug 25 on the core axis 21 blocks the shower head water output channel, to cause the connection of the water output slot 213 to the shower water output channel.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A front-knob type multi-function shower arm, comprising:
a main body, including:
a water input interface, disposed at a rear end of the main body;
a shower head interface, disposed at a front end upper portion of the main body, and used for installing a shower head;
a shower interface, disposed at a front end bottom portion of the main body, and used for connecting to a shower hose;
a three-way splitter, disposed in the main body, for controlling flow of water to the shower head or a shower; and
a knob, disposed at a front face of front end lower portion of the main body, used to operate the three-way splitter.

2. The front-knob type multi-function shower arm as claimed in claim 1, wherein the main body is of a V shape, and an axial line of the water input interface is parallel to ground, while a connector is installed in the shower head interface through its inner threads for connecting a shower head, the connector is inclined downward, with its middle portion provided with a ring shape indent slot, and an O-shape tight seal ring is received in the ring shape indent slot, in tight seal contact with an inner wall of the shower head interface.

3. The front-knob type multi-function shower arm as claimed in claim 1, wherein the three-way splitter includes a core axis installed slantwise at a T-joint in the main body, an operation end of the core axis penetrating through a through hole in a center of a press disk, and is exposed to a front face of the main body, and the press disk is locked tightly on the main body through using a screw, so that a knob is fastened onto the operation end of the core axis.

4. The front-knob type multi-function shower arm as claimed in claim 3, wherein a ring shape indent slot is each provided on both ends of the core axis, the O-shape tight seal ring is sleeved around the ring shape indent slot in tight seal contact with an inner wall of the main body, in a middle portion and on a side of the core axis is provided with a positioning slot, in the positioning slot is provided with a tight seal plug for selectively sealing a shower head water output channel or a shower water output channel through using a tight seal spring, in the middle portion and on the other side of the core axis is provided with a water output slot, connecting to the shower head water output channel or the shower water output channel, a water input hole is provided at a rear end of the core axis for connecting the water input channel and the water output slot, and a bottom portion of the water output slot is connected to a bottom portion of the positioning slot through a small hole.

5. The front-knob type multi-function shower arm as claimed in claim 4, wherein a plurality of ribs are disposed at the bottom portion of the water output slot, to slow down the speed of water flow.

6. The front-knob type multi-function shower arm as claimed in claim 1, wherein a flange is provided around a rear end outer side of the main body.

7. A water output method used to perform a front-knob type multi-function shower arm as claimed in claim 1, comprising following two water output modes:
(1) a shower head water output mode: when rotating upward a knob on a front face, a three-way splitter is brought to connect a water input channel of a main body to a shower head water output channel, so that water flows to the shower head water output channel, and then flows directly out from a shower head; and
(2) a shower water output mode: when rotating downward a knob on a front face, the three-way splitter is brought to connect the water input channel of the main body to the shower water output channel, so that water flows to the shower water output channel, and then flows out a shower from an outside connected shower hose.
